(19) United States
(12) Patent Application Publication
(10) Pub. No.: US 2022/0365869 A1
(43) Pub. Date: Nov. 17, 2022

(54) Debug Test System, Target System, Methods, and Computer Programs

(71) Applicant: Intel Corporation, Santa Clara, CA (US)

(72) Inventors: Subinlal PK, Calicut (IN); Keith JONES, Forest Grove, WA (US); Rolf KUEHNIS, Portland, OR (US)

(21) Appl. No.: 17/456,583

(22) Filed: Nov. 25, 2021

(51) Int. Cl. G06F 11/36

(52) U.S. Cl. CPC G06F 11/3664; G06F 11/362

(57) ABSTRACT

A debug test system is provided. The debug test system includes one or more interfaces configured to communicate with a target system and processing circuitry configured to control the one or more interfaces. Further, the processing circuitry is configured to receive information about an operation state of the target system from the target system and to generate control information for the target system to adjust a debug session on the target system. The processing circuitry is further configured to transmit the control information to the target system.

### BACKGROUND

Debug is used to detect, triage, trace, and potentially eliminate mistakes, or bugs, in hardware and software. For debugging typically a debug and test system (DTS) is utilized that provides a system developer debug visibility and control when connected to a target system (TS). From other systems run control (probe mode debug) or crashlog end-to-end flow (software/firmware debug feature) are known. The crashlog (e.g., the Intel CrashLog) needs to be enabled on a platform and if it needs to work effectively, there are associated (firmware) timers that need to be enabled, e.g., through system firmware. If such a timer gets enabled, then it impacts a probe mode debug solution. Thus, there may be a need to improve a debug session of a target system.

### BRIEF DESCRIPTION OF THE FIGURES

Some examples of apparatuses and/or methods will be described in the following by way of example only, and with reference to the accompanying figures, in which

FIG. 1 shows an example of a crashlog know from other systems;

FIG. 2 shows a block diagram of an example of a debug test system;

FIG. 3 shows an example of a system comprising a debug test system and a target system;

FIGS. 4a and 4b show two different examples of a crashlog end-to-end flow;

FIG. 5 shows a block diagram of an example of a target system;

FIG. 6 shows an example of a method for a debug test system;

FIG. 7 shows another example of a method for a debug;

FIG. 8 shows an example of a method for a target system; and

FIG. 9 shows a computing device.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of the group A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

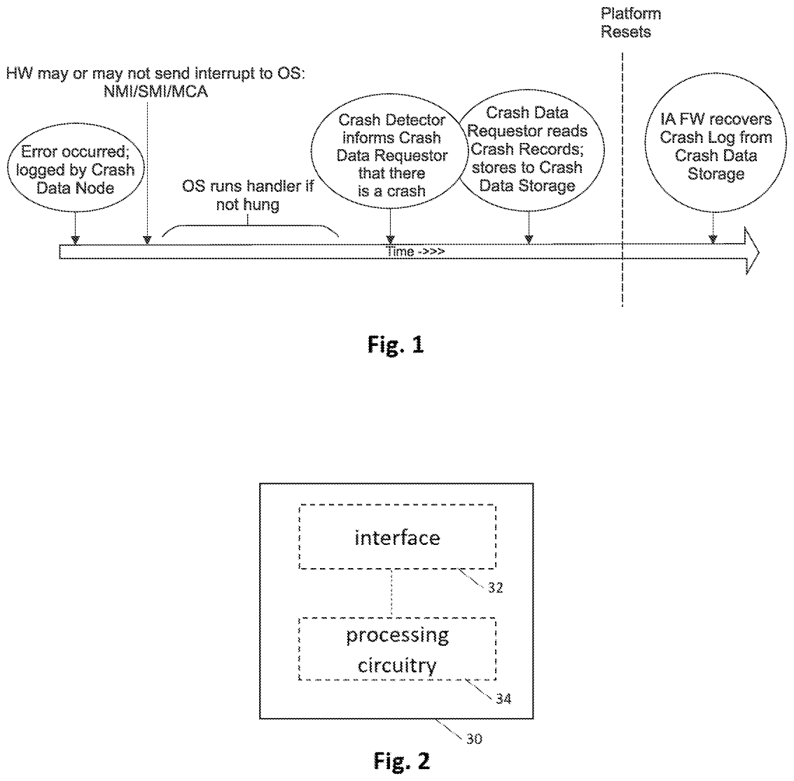

FIG. 1 shows an example of a crashlog 100 know from other systems. The crashlog 100, e.g., the Intel CrashLog, is a platform level feature to capture and preserve hardware state such that it survives a set of a platform reset types and make a log of the crash available to both humans and external systems to help in the triage and failure analysis process. The crashlog solution includes software components to detect, extract, decode and analyze the log, providing immediate natural language diagnostics of the crash.

As can be seen in FIG. 1 the use of a crashlog comprises the use of a reset timer (also known as watchdog timer from other systems) to trigger a platform reset. The reset timer is set in advance such that a target system will be reset after a predefined time after a crashlog event has occurred.

On halting the processor cores for debug, the reset timer can expire and cause the platform to reset while an active debug session is still in progress. This is not a desirable debug solution that a debug user will wish for, because the user will lose the original failing state of the target system, which is under debug, if the target system resets during a debug session. Thus, if the user wants to debug the target system, he has to decide either if he wants to use a crashlog comprising the use of a reset timer or a run control without a reset timer. Therefore, a user experience may be significantly increased by allowing a user to access both a crashlog and a run control for the same debug session, especially if an undesired reset of the system can be prevented. This can be achieved by use of the debug test system as described below, e.g., with reference to FIG. 2.

FIG. 2 shows a block diagram of an example of a debug test system 30. The debug test system 30 comprises one or more interfaces 32 configured to communicate with a target system and processing circuitry 34 configured to control the one or more interfaces 32. Further, the processing circuitry 34 is configured to receive information about an operation state of the target system from the target system and to generate control information for the target system to adjust a debug session on the target system. The processing circuitry 34 is further configured to transmit the control information to the target system. By receiving information about an operation state of the target system (e.g., a catastrophic error, a sleep mode of a processing unit, etc.) the processing circuitry 34 can generate control information comprising information which affect the operation state of the target system or a future operation state of the target system. This way, the target system can be informed about possible measures, e.g., measures selected by a user, to proceed. For example, a reset timer of the target system may be adjusted/deactivated/replaced by use of the control information.

By use of the debug test system 30 as described with reference to FIG. 2 the user is enabled to use both the run control (probe mode debug) and the crashlog end-to-end flow on the target system simultaneously, avoiding an undesired reset of the target system. For example, the (firmware based) reset timer may be replaced with a probe mode debug timer. Further, the user may be notified if there is a crash event during a debug session. The debug user can then decide if a debug session should continue (e.g., by replacing the reset timer by a debug mode timer) or a crashlog end-to-end flow (comprising a reset) should continue.

The target system may be a processing unit debugged up to a Debug and Test Interface (DTI), e.g., the one or more interfaces 32. The target system might be a discrete device (such like a chip, processing unit, etc.) or a collection of 1 to N discrete devices grouped on a board or collection of boards. The target system might also contain 0 to N individual debug and test targets.

The debug test system 30 may be a combined hardware and software system that provides a user debug visibility and control when connected to the target system. The debug test system 30 may comprise a host personal computer, such like a workstation or another processing system, e.g., a processing unit, running the debug or test software, controlling the debug and test controller and a debugger software. The debugger software may be a part of the debug test system 30 and may interact with the debug and test controller and provides the (graphical) user interface for operating the debug and test controller (like commanding single processes, setting breakpoints, memory display/modify, trace reconstruction, etc.).

The operation state of the target system may belong to various parameters of the target system, e.g., a cater of a processing unit, a functional state (such like sleep, power, clock, etc.), a firmware/software status, a hardware configuration/activity (e.g., a deactivated interface), etc.

The control information may comprise information which affects the operation state of the target system. For example, the control information can comprise a request to change a hardware activity, e.g., turn on a deactivated interface such like a universal serial bus, to change a functional state, e.g., change a performance mode of a processing unit, etc. Optionally, the control information may comprise information which affects a future operation state of the target system. For example, the control information can comprise a probe mode debug timer. Thus, a reset timer of the target system can be adjusted/replaced by the probe mode debug timer, such that a reset of the target system in the future can be changed.

The control information can be generated fully automatically. For example, depending on an operation state of the target system (e.g., a massive rack-test system), e.g., a state of a program (e.g., an early research and development state, a software validation, a final acceptance testing), a crash reason (e.g., a catastrophic error, etc.), etc. different actions might be performed with the target system. Thus, the control information may comprise different measures for the different operation states. By receiving information about the operation the processing circuitry 34 can generate the control information, e.g., by use of a database stored in a data storage medium. For example, for different crash reasons, states of program, etc. a look-up table may be utilized to determine the control information. This way, the processing circuitry 34 can determine an appropriate measure automatically. For example, the database (e.g., the look-up table) can be maintained by a user, such that the automatically chosen measures can be updated.

Optionally or alternatively, the control information can be generated based on a user input. In an example, the processing circuitry 34 may be further configured to provide information about the operation state of the target system to a user and to generate the control information for the target system based on a user input. This way, the user may decide/provide information on how he wants to proceed with a running debug session, which may increase the user experience. For example, the user may be informed about an operation state of the target system that requires a reset which will be performed after expiration of a reset timer. Thus, the user may provide a user input to change the reset timer to avoid a reset, e.g., the user may define a debug mode timer which may adjust/replace the reset timer.

For example, the information provided to the user may inform the user about a harm for the user or the target system. Typically a platform has some protection circuitry, preventing the system from overheating, burning, or hanging forever. Thus, there may be different reasons to reset the target system which are not fully healthy for the target system. Further, the protection circuitry may prevent the target system from a fatal error and/or protect the user from an injury (e.g. an electric shock, etc.). For example, the user may receive information on the exact operation state of the target system, such that he can base an adjustment of the reset timer based on the reason for setting the reset timer, e.g., if a reset is needed to prevent a fatal error of the target system the user may chose if he wants to adjust/replace the reset timer (risking the fatal error of the target system) or if he wants to proceed as usually (e.g., allowing a reset of the target system).

By generating the control information and/or by providing the information about the operation state the user don't need to worry about any debug settings on the target system or operation states of the target system impacting a debug session. Thus, a user experience can be improved. Further, this can also help a user to debug previously seen failure without losing the symptom (e.g., a failure which is very hard to reproduce) even after a target system crashes.

Optionally, the user input may be stored, e.g., in the database in the data storage medium, such that this user input can be used for future events. For example, if the received information about the operation station indicates an operation for which a user has already made a user input (e.g., the operation state appears periodically) the processing circuitry 34 may use the database to generate the control information such that multiple user inputs for the same operation state can be avoided.

In an example, the processing circuitry 34 may be further configured to transmit the control information by use of a virtual register space, physical register, virtual register, wire or event. In an example, the virtual register space may comprise an inter process communication (IPC) mailbox. This way, an improved communication between the debug test system 30 and the target system can be achieved, e.g., for transmitting the control information. Further, the information may be transmitted by use of an action message or event message in a protocol, e.g., the MIPI SneakPeek protocol, MIPI Trace Wrapper protocol, MIPI Gigabit Trace protocol. For example, any protocol with integrated trigger support, e.g., to use trace path to indicate the reset timer (and rather not the run-control protocol), can be utilized.

In an example, the processing circuitry 34 may be further configured to transmit the control information by use of a JTAG connector and/or an in-band interrupt in I2C, I3C or a packet over universal serial bus. For example, the control information can be transmitted by a signal on the JTAG connector and/or an interrupt in a MIPI I3C.

In an example, the control information may comprise information about a flow of the debug session. This way, a flow of the debug session can be adjusted, e.g., a reset of the target system can be scheduled in accordance with a previous flow process.

In an example, the information about the flow of the debug session may comprise information about a deactivation of a target system reset timer. Thus, a reset of the target system can be disabled. For example, the reset timer can be replaced by a debug mode timer, which causes a reset of the target system, e.g., based on the user input. The reset timer can be used in particular to reset the target system during a debug session.

In an example, the control information may comprise information about a power status of a hardware component of the target system. For example, the power status may be a hardware configuration/activity. This way, a used hardware component, e.g., an interface, can be controlled by the debug test system 30. For example, a user may need an interface of the target system, e.g., a universal serial bus, and thus the user is enabled to configure the hardware component of the target system.

For example, the power status may also comprise information about critical timers on the target system. As described above a target system typically has some protection circuitry, preventing the target system from overheating, burning, hanging forever, etc. Thus, there are different reasons to restart a target system which isn't fully healthy. The power status may comprise information about critical reset timers corresponding to these failures. Thus, the reset timer may also be a used as a fail-safe logic, preventing the system from fatal errors or protect the user from injury (e.g. electric shock). Therefore, the user must be aware if he changes the reset timer, which impact this may have on the target system, e.g., an overheating. Information about this can be provided the user simultaneously by providing the user information about the operation state.

The debug test system 30 may be a computer, processor, control unit, (field) programmable logic array ((F)PLA), (field) programmable gate array ((F)PGA), graphics processor unit (GPU), application-specific integrated circuit (ASICs), integrated circuits (IC) or system-on-a-chip (SoCs) system. The target system may be a computer, processor, control unit, (field) programmable logic array ((F)PLA), (field) programmable gate array ((F)PGA), graphics processor unit (GPU), application-specific integrated circuit (ASICs), integrated circuits (IC) or system-on-a-chip (SoCs) system.

As shown in FIG. 2 the respective one or more interfaces 32 are coupled to the respective processing circuitry 34 at the debug test system 30. In examples the processing circuitry 34 may be implemented using one or more processing units, one or more processing devices, any means for processing, such as a processor, a computer or a programmable hardware component being operable with accordingly adapted software. Similar, the described functions of the processing circuitry 34 may as well be implemented in software, which is then executed on one or more programmable hardware components. Such hardware components may comprise a general-purpose processor, a Digital Signal Processor (DSP), a micro-controller, etc. The processing circuitry 34 is capable of controlling the interface 32, so that any data transfer that occurs over the interface and/or any interaction in which the interface may be involved may be controlled by the processing circuitry 34.

In an embodiment the debug test system 30 may comprise a memory and at least one processing circuitry 34 operably coupled to the memory and configured to perform the below mentioned method.

In examples the one or more interfaces 32 may correspond to any means for obtaining, receiving, transmitting or providing analog or digital signals or information, e.g. any connector, contact, pin, register, input port, output port, conductor, lane, etc. which allows providing or obtaining a signal or information. An interface may be wireless or wireline and it may be configured to communicate, e.g., transmit or receive signals, information with further internal or external components. The one or more interfaces 32 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

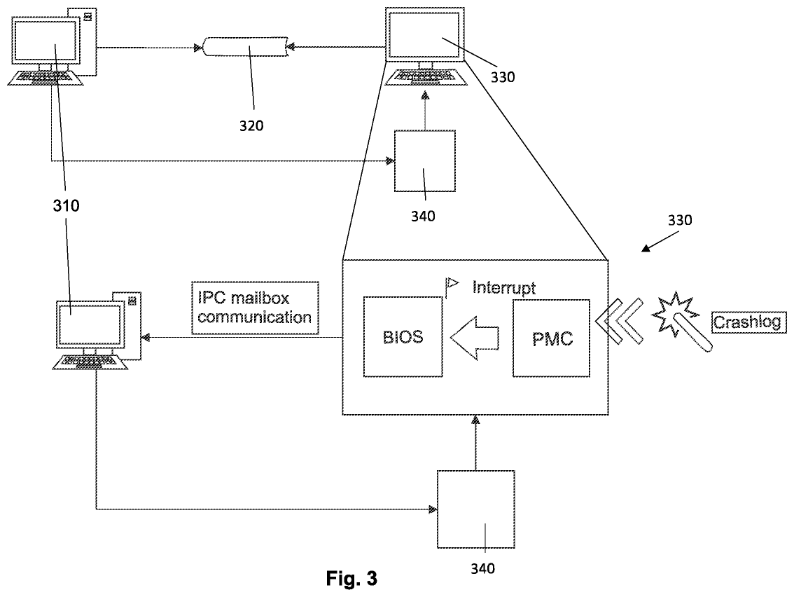

More details and aspects are mentioned in connection with the examples described below. The example shown in FIG. 2 may comprise one or more optional additional features corresponding to one or more aspects mentioned in connection with the proposed concept or one or more examples described below (e.g., FIG. 3-9).

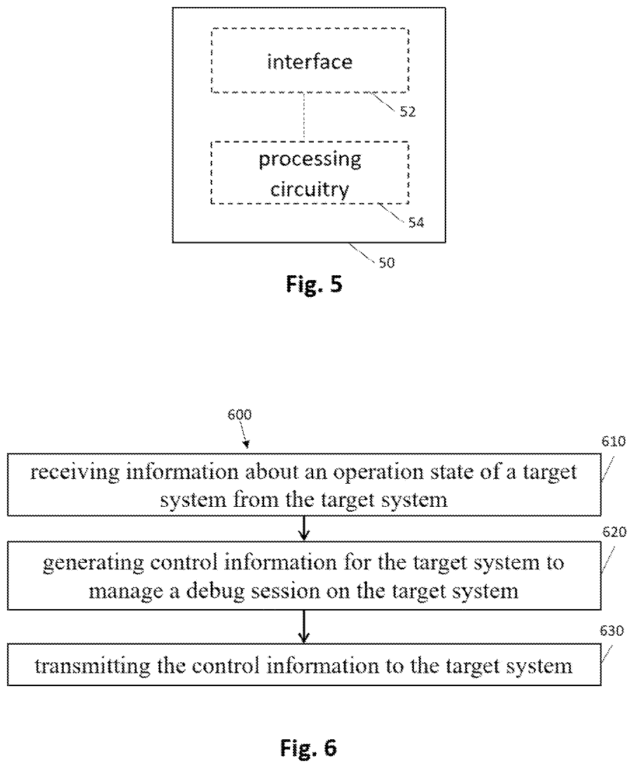

FIG. 3 shows an example of a system comprising a debug test system 310 and a target system 330. The debug test system 310 may be a debug test system 310 as described above, e.g., with reference to FIG. 2. The target system 330 may be a target system 330 as described below, e.g., with reference to FIG. 5. A communication between the debug test system 310 and the target system 330 may be performed by use of an IPC mailbox 320. For example, the information about the operation state of the target system 330 and/or the control information generated by the debug test system 310 may be transmitted/received by use of the IPC mailbox 320.

Note, FIG. 3 depicts two links between the debug test system 310 and the target system 330. However, the link between the debug test system 310 and the target system 330 can be a single bi-directional link.

For example, by using the control information instead of a reset timer resetting the target system 330 after a crash event has occurred, a debug software design can be changed. An interrupt can be triggered to a power management controller (PMC) or reset controller of the target system 330 on a crash event and the PMC can communicate to the debug test system 310, e.g., a debug test system software, that there is a crash event that has occurred. Based on the information received over the IPC mailbox communication the debug test system 310, e.g., a software of the debug test system 310, can provide a user information about the crash event, e.g., the operation state of the target system 330. The debug test system 310 may provide the information by prompting a message to the user on a monitor of the debug test system 310. For example, the information prompted may give the user a choice either to reset the target system 330 at this point, e.g., to initiate a crashlog end-to-end flow, or to continue with a debug session.

The debugger-based reset timer needs to be enabled only if an active debugger hardware 340 is connected. At time 0 when a debugger hardware 340 is connected to the target system 330, the reset timer gets auto off (based on the communication between the debug test system 310 and the target system 330 via the IPC mailbox communication), for example.

While the target system 330 is active if there is a crash event, then an interrupt is generated to the PMC and then the PMC talks to the debug test system 310 indicating that there is a crash event (e.g., over the IPC mailbox communication). Now the debug test system 310 can notify the user with an option to continue with the current debug session or to proceed with a crashlog end-to-end flow. The control on the decision may be with the debug user, e.g., can be received by the user input. If the user decides to continue with the crashlog end-to-end flow then the debugger hardware 340 can trigger a reset (e.g., by writing to CF9) to the target system 330 and the target system 330 can continue with a typical crashlog end-to-end flow. This way, the user is enabled to use both the crashlog end-to-end flow and the run control.

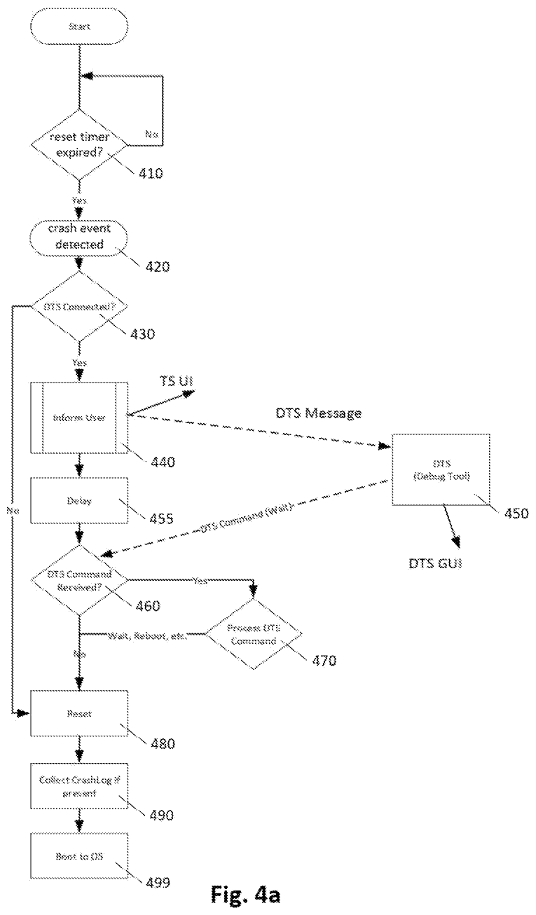

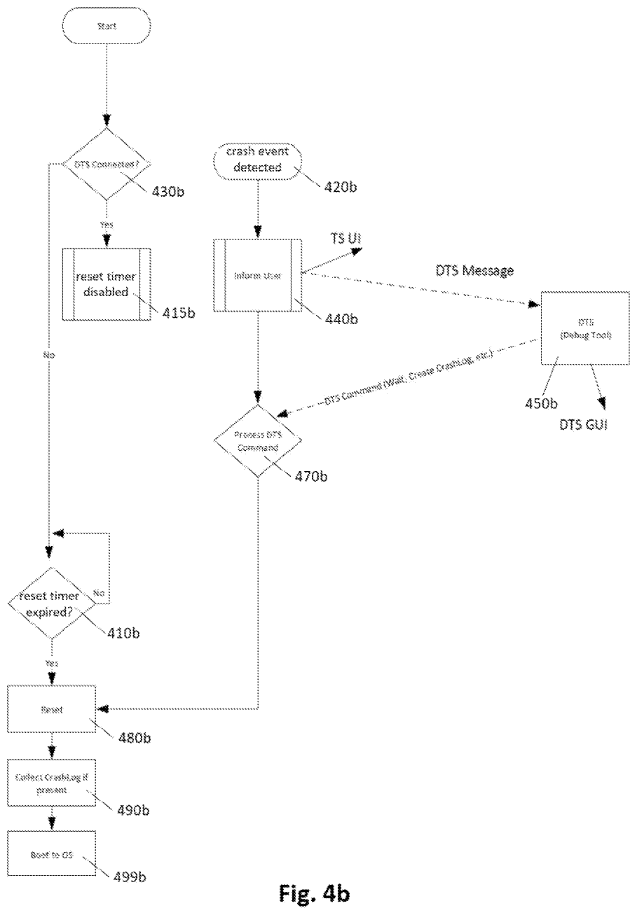

More details and aspects are mentioned in connection with the examples described above and/or below. The example shown in FIG. 3 may comprise one or more optional additional features corresponding to one or more aspects mentioned in connection with the proposed concept or one or more examples described above (e.g., FIG. 1-2) and/or below (e.g., FIG. 4-9).

FIGS. 4a and 4b show two different examples of a crashlog end-to-end flow. As can be seen in FIG. 4a a crashlog reset timer is comprised by a default configuration. If the reset timer is expired 410 and a crash event is detected 420 a check 430 if a debug test system (DTS) is connected may be performed. If no debug test system is detected the crashlog end-to-end flow may skip to perform a reset 480 of the target system. If a debug test system is detected the debug test system may inform 440 a user about the crash event detected 420, e.g., by use of user interface such like a monitor of the debug test system.

The debug test system may receive a user input and may generate a debug test system message comprising information about the user input. The debug test system, e.g., a debug tool, may generate 450 a debug test system command based on the information of the debug system test message. The target system may check 460 if a debug test system command was received. For example, the target system may only check 460 for the debug test system command after a delay is expired 450.

If a debug test system command was received 460 the target system may process 470 the debug test system command, e.g., may replace a reset timer by a debug mode timer. After processing 470 the debug test system command the target system may perform a reset 480, e.g., after the debug mode timer is expired. Further, a crashlog may be collected 490 if present and the target system may be booted 499 to the operation system.

FIG. 4b shows a different crashlog end-to-end flow. In contrast to FIG. checking 430b if a debug test system is connected will be performed before checking 410b an expiration of the reset time. If a debug test system is connected the reset timer is disabled 415b. After disabling 415b the reset timer if a crash event is detected 420b a user may be informed 440b about the crash event.

Again the debug test system may receive a user input and may generate a debug test system message comprising information about the user input. The debug test system, e.g., a debug tool, may generate 450b a debug test system command based on the information of the debug system test message. The target system may process 470 the debug test system command. After processing 470b the debug test system command or after expiration 410b of the reset timer the target system may be reset 480b. Further, a crashlog may be collected 490 if present and the target system may be booted 499 to the operation system.

The end-to-end flow described with reference to FIG. 4a may be more complex but follows more of the standard execution. In the end-to-end flow described with reference to FIG. 4b a decision to deviate from the standard flow is done early and therefore simplifies the flow in the later phase.

Normally, BIOS, OS, PMIC, or other firmware agents initiates the reset timer and disables it, which may help to enable probe mode debug for the target system but also disables a crashlog end-to-end flow. By checking if a debug test system is connected to the target system and disabling/adjusting the reset timer both debug solutions, run control and crashlog end-to-end flow can be used simultaneously. Thus, a currently mutual exclusive usage known from other systems can be omitted.

More details and aspects are mentioned in connection with the examples described above and/or below. The example shown in FIG. 4 may comprise one or more optional additional features corresponding to one or more aspects mentioned in connection with the proposed concept or one or more examples described above (e.g., FIG. 1-3) and/or below (e.g., FIG. 5-9).

FIG. 5 shows a block diagram of an example of a target system 50. The target system 50 comprises one or more interfaces 52 configured to communicate with a debug test system and processing circuitry 54 configured to control the one or more interfaces 52. Further, the processing circuitry 54 is configured to transmit information about an operation state to the debug test system, to receive control information from the debug test system and to adjust a parameter of a debug session based on the received control information. For example, the debug test system may be the debug test system as described above, e.g., with reference to FIG. 2.

In an example, if no control information is received within a predefined time the processing circuitry 54 may be further configured to proceed with the debug session without adjusting the parameter of the debug session. For example, if no control information (e.g., a debug test system command) is received within a delay time the target system may be reset according to a reset timer (compare FIG. 4a). Thus, if the user does not provide a user input the target system may run as usual even if a debug test system is connected (expect of a delay time).

In an example, the parameter of the debug session comprises a target system reset timer. Further, the processing circuitry 54 may be further configured to deactivate the target system reset timer after transmitting the control information to the debug test system. For example, the control information may comprise a debug mode timer to replace the reset timer, such that an undesired event/reset of the target system can be avoided.

In an example, the parameter of the debug session comprises information about at least one element of the group of a target system reset timer, a power status of a hardware component; an addressed logic array of the debug session, a context, a logic failure of a processing unit and a debug session flow. Further, the parameter of the debug session may belong to any memory value and/or register value of the target system, for example. Optionally, the parameter of the debug session may belong to scan information and/or trace information/indicating progress in software and/or hardware operation state of the target system.

In an example, the processing circuitry 54 may be further configured to transmit the information about the operation state by use of a virtual register space, physical register, virtual register, wire or event. In an example, the virtual register space may comprise an inter process communication (IPC) mailbox. This way, an improved communication between the debug test system and the target system can be achieved, e.g., for transmitting the control information. Further, the information may be transmitted by use of an action message or event message in the MIPI SneakPeek protocol.

In an example, the processing circuitry 54 may be further configured to transmit the control information by use of a JTAG connector and/or an in-band interrupt in I3C or a packet over universal serial bus. For example, the control information can be transmitted by a signal on the JTAG connector and/or an interrupt in a MIPI I3C.

The target system 50 may be a computer, processor, control unit, (field) programmable logic array ((F)PLA), (field) programmable gate array ((F)PGA), graphics processor unit (GPU), application-specific integrated circuit (ASICs), integrated circuits (IC) or system-on-a-chip (SoCs) system.

As shown in FIG. 5 the respective one or more interfaces 52 are coupled to the respective processing circuitry 54 at the debug test system 50. In examples the processing circuitry 54 may be implemented using one or more processing units, one or more processing devices, any means for processing, such as a processor, a computer or a programmable hardware component being operable with accordingly adapted software. Similar, the described functions of the processing circuitry 54 may as well be implemented in software, which is then executed on one or more programmable hardware components. Such hardware components may comprise a general-purpose processor, a Digital Signal Processor (DSP), a micro-controller, etc. The processing circuitry 54 is capable of controlling the interface 52, so that any data transfer that occurs over the interface and/or any interaction in which the interface may be involved may be controlled by the processing circuitry 54.

In an embodiment the debug test system 50 may comprise a memory and at least one processing circuitry 54 operably coupled to the memory and configured to perform the below mentioned method.

In examples the one or more interfaces 52 may correspond to any means for obtaining, receiving, transmitting or providing analog or digital signals or information, e.g. any connector, contact, pin, register, input port, output port, conductor, lane, etc. which allows providing or obtaining a signal or information. An interface may be wireless or wireline and it may be configured to communicate, e.g., transmit or receive signals, information with further internal or external components. The one or more interfaces 52 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described above and/or below. The example shown in FIG. 5 may comprise one or more optional additional features corresponding to one or more aspects mentioned in connection with the proposed concept or one or more examples described above (e.g., FIG. 1-4) and/or below (e.g., FIG. 6-9).

FIG. 6 shows an example of a method 600 for a debug test system. The method 600 comprises receiving 610 information about an operation state of a target system from the target system, generating 620 control information for the target system to manage a debug session on the target system. Further, the method 600 comprises transmitting 630 the control information to the target system. The method 600 may be performed by a debug test system as described above, e.g., described with reference to FIG. 2.

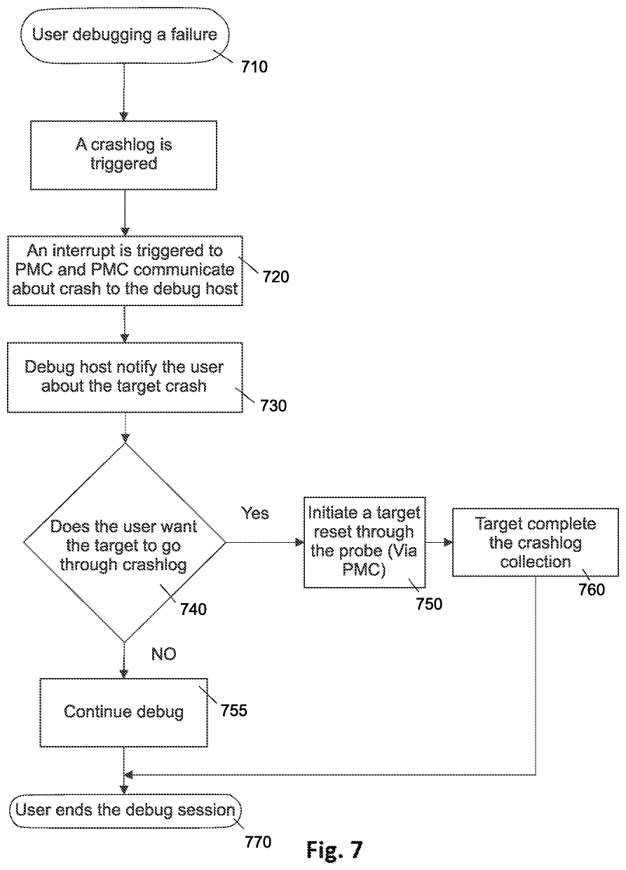

More details and aspects are mentioned in connection with the examples described above and/or below. The example shown in FIG. 6 may comprise one or more optional additional features corresponding to one or more aspects mentioned in connection with the proposed concept or one or more examples described above (e.g., FIG. 1-5) and/or below (e.g., FIG. 7-9).

FIG. 7 shows another example of a method 700 for a debug. As can be seen in FIG. 7, if a crash event had occurred on a target system where a user is debugging 710 a failure, the target system would send 720 an interrupt to the debug test system, e.g., a host software of the debug test system, via IPC mailbox communication indicating that there is a crash event on the target system. The host software on the debug test system then displays 730 information to the user, e.g., via a dialog popup message, asking, if the user wants to continue the debug session or would like to go through the crashlog end-to-end flow. If the user decides 740 to continue with the current debug session, then a PMC will not generate a global reset (or any other reset event known from other systems) and would allow the user to continue 755 the debug session (as there would not be any change of operation state in the target system). In the second case if the user decides to go through the complete crashlog end-to-end flow then the PMC triggers 750 a reset and then the target system would complete 760 the crashlog collection with the help of BIOS. This way the complete control on the target system for debuggability is with the user when there is a co-existence of probe mode debug/run-control and software/firmware based debug solutions on the target system (SoC). Note, even in FIG. 7 the method is shown with respect to a PMC this method could be applied to other agents known from other systems.

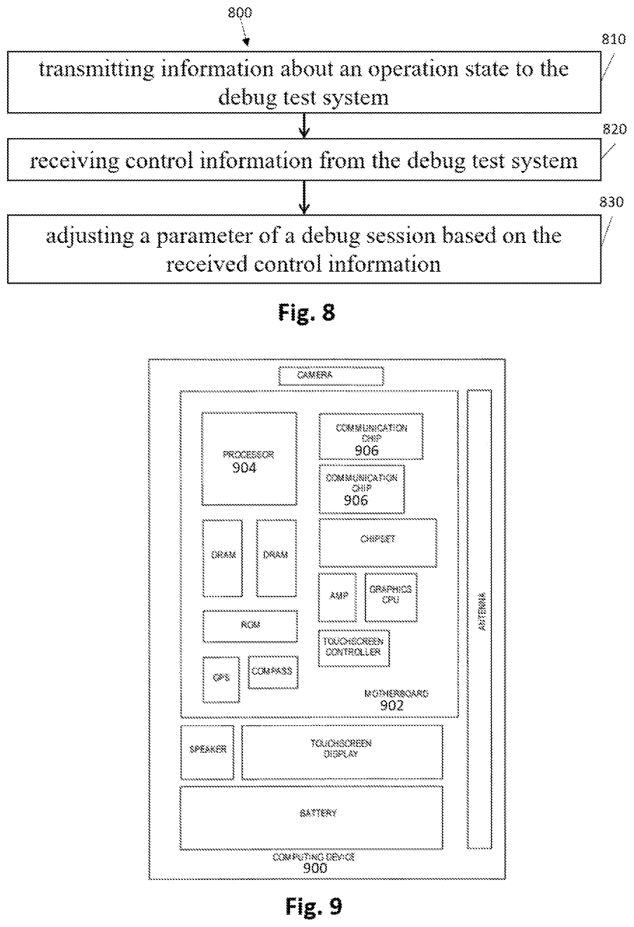

More details and aspects are mentioned in connection with the examples described above and/or below. The example shown in FIG. 7 may comprise one or more optional additional features corresponding to one or more aspects mentioned in connection with the proposed concept or one or more examples described above (e.g., FIG. 1-6) and/or below (e.g., FIG. 8-9).

FIG. 8 shows an example of a method 800 for a target system. The method 800 comprises transmitting 810 information about an operation state to the debug test system, receiving 820 control information from the debug test system and adjusting 830 a parameter of a debug session based on the received control information.

More details and aspects are mentioned in connection with the examples described above and/or below. The example shown in FIG. 8 may comprise one or more optional additional features corresponding to one or more aspects mentioned in connection with the proposed concept or one or more examples described above (e.g., FIG. 1-7) and/or below (e.g., FIG. 9).

FIG. 9 shows a computing device 900. The computing device 900 houses a board 902. The board 902 may include a number of components, including but not limited to a processor 904 and at least one communication chip 906. A semiconductor device as described above (e.g., the target system described with reference to FIG. 2) may be the processor 904 as shown in FIG. 9.

The processor 904 is physically and electrically coupled to the board 902. In some examples the at least one communication chip 906 is also physically and electrically coupled to the board 902. In further examples, the communication chip 906 is part of the processor 904.

Depending on its applications, computing device 900 may include other components that may or may not be physically and electrically coupled to the board 902. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 906 enables wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not. The communication chip 906 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 900 may include a plurality of communication chips 906. For instance, a first communication chip 906 may be dedicated to shorter range wireless communications such as Wi-Fi and Bluetooth and a second communication chip 906 may be dedicated to longer range wireless communications such as GPS, EDGE, GPRS, CDMA, WiMAX, LTE, Ev-DO, and others.

The processor 904 of the computing device 900 includes an integrated circuit die packaged within the processor 904. In some examples, the integrated circuit die of the processor includes one or more devices that are assembled in an ePLB or eWLB based P0P package that that includes a mold layer directly contacting a substrate, in accordance with examples. The term “processor” may refer to any device or portion of a device that processes electronic data from registers and/or memory to transform that electronic data into other electronic data that may be stored in registers and/or memory.

The communication chip 906 also includes an integrated circuit die packaged within the communication chip 906. In accordance with another example, the integrated circuit die of the communication chip includes one or more devices that are assembled in an ePLB or eWLB based P0P package that that includes a mold layer directly contacting a substrate, in accordance with examples.

More details and aspects are mentioned in connection with the examples described above. The example shown in FIG. 9 may comprise one or more optional additional features corresponding to one or more aspects mentioned in connection with the proposed concept or one or more examples described above (e.g., FIG. 1-8).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

An example (e.g., example 1) relates to a debug test system, comprising one or more interfaces configured to communicate with a target system; and processing circuitry configured to control the one or more interfaces and to: receive information about an operation state of the target system from the target system; generate control information for the target system to adjust a debug session on the target system; and transmit the control information to the target system.

Another example (e.g., example 2) relates to a previously described example (e.g., example 1) wherein the processing circuitry is further configured to: provide information about the operation state of the target system to a user; and generate the control information for the target system based on a user input.

Another example (e.g., example 3) relates to a previously described example (e.g., one of the examples 1-2) wherein the processing circuitry is further configured to transmit the control information by use of a virtual register space.

Another example (e.g., example 4) relates to a previously described example (e.g., the example 3) the virtual register space comprises an inter process communication, IPC, mailbox.

Another example (e.g., example 5) relates to a previously described example (e.g., one of the examples 1-4) wherein the processing circuitry is further configured to transmit the control information by use of a JTAG connector and/or an in-band interrupt in I2C, I3C or a packet over universal serial bus.

Another example (e.g., example 6) relates to a previously described example (e.g., one of the examples 1-5) wherein the control information comprises information about a flow of the debug session.

Another example (e.g., example 7) relates to a previously described example (e.g., the example 6) wherein the information about the flow of the debug session comprises information about a deactivation of a target system reset timer.

Another example (e.g., example 8) relates to a previously described example (e.g., one of the examples 1-7) wherein the control information comprises information about a power status of a hardware component of the target system.

An example (e.g., example 9) relates to a target system, comprising one or more interfaces configured to communicate with a debug test system; and processing circuitry configured to control the one or more interfaces and to: transmit information about an operation state to the debug test system; receive control information from the debug test system; and adjust a parameter of a debug session based on the received control information.

Another example (e.g., example 10) relates to a previously described example (e.g., the example 9) wherein if no control information is received within a predefined time the processing circuitry is further configured to proceed with the debug session without adjusting the parameter of the debug session.

Another example (e.g., example 11) relates to a previously described example (e.g., one of the examples 9-10) wherein the parameter of the debug session comprises a target system reset timer and wherein the processing circuitry is further configured to deactivate the target system reset timer after transmitting the control information to the debug test system.

Another example (e.g., example 12) relates to a previously described example (e.g., one of the examples 9-11) wherein the parameter of the debug session comprises information about at least one element of the group of a target system reset timer; a power status of a hardware component; an addressed logic array of the debug session; a context; a logic failure of a processing unit; and a debug session flow.

Another example (e.g., example 13) relates to a previously described example (e.g., one of the examples 9-12) wherein the processing circuitry is further configured to transmit the information about the operation state by use of a virtual register space.

Another example (e.g., example 14) relates to a previously described example (e.g., the example 13) wherein the virtual register space comprises an inter process communication, IPC, mailbox.

Another example (e.g., example 15) relates to a previously described example (e.g., one of the examples 9-14) wherein the processing circuitry is further configured to transmit the control information by use of a JTAG connector and/or an in-band interrupt in I2C, I3C or a packet over universal serial bus

An example (e.g., example 16) relates to a method for a debug test system, comprising receiving information about an operation state of a target system from the target system; generating control information for the target system to manage a debug session on the target system; and transmitting the control information to the target system.

Another example (e.g., example 17) relates to a previously described example (e.g., example 16) further comprising providing information about the operation state of the target system to a user; and generating the control information for the target system based on a user input.

Another example (e.g., example 18) relates to a previously described example (e.g., one of examples 16-17) wherein the information about the operation state is transmitted by use of a virtual register space.

Another example (e.g., example 19) relates to a previously described example (e.g., one of examples 16-18) wherein the information about the flow of the debug session comprises information about a deactivation of a target system reset timer.

Another example (e.g., example 20) relates to a previously described example (e.g., one of examples 16-19) wherein the control information comprises information about a power status of a hardware component of the target system.

An example (e.g., example 21) relates to a non-transitory, computer-readable medium comprising a program code that, when the program code is executed on a computer, a processor, or a programmable hardware component, performs one of the above examples (e.g., one of the examples 16-20).

An example (e.g., example 21a) relates to a computer program having a program code for performing the method of the above examples (e.g., one of the examples 16-20), when the computer program is executed on a computer, a processor, or a programmable hardware component.

An example (e.g., example 22) relates to a method for a debug test system, comprising transmitting information about an operation state to the debug test system; receiving control information from the debug test system; and adjusting a parameter of a debug session based on the received control information.

An example (e.g., example 23) relates to a non-transitory, computer-readable medium comprising a program code that, when the program code is executed on a computer, a processor, or a programmable hardware component, performs one of the above examples (e.g., the example 22).

An example (e.g., example 23a) relates to a computer program having a program code for performing the method of the above examples (e.g., the example 22), when the computer program is executed on a computer, a processor, or a programmable hardware component.

An example (e.g., example 24) relates to a debug test system, comprising means for processing and means for storing information, wherein the debug test system is configured to receive information about an operation state of the target system from the target system; generate control information for the target system to adjust a debug session on the target system; and transmit the control information to the target system.

An example (e.g., example 25) relates to a target system, comprising means for processing and means for storing information, wherein the target system is configured to control the one or more interfaces and to: transmit information about an operation state to the debug test system; receive control information from the debug test system; and adjust a parameter of a debug session based on the received control information.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A debug test system, comprising
one or more interfaces configured to communicate with a target system; and
processing circuitry configured to control the one or more interfaces and to:
receive information about an operation state of the target system from the target system;
generate control information for the target system to adjust a debug session on the target system; and
transmit the control information to the target system.

2. The debug test system according to claim 1, wherein
the processing circuitry is further configured to:
provide information about the operation state of the target system to a user; and
generate the control information for the target system based on a user input.

3. The debug test system according to claim 1, wherein
the processing circuitry is further configured to transmit the control information by use of a virtual register space, physical register, virtual register, wire or event.

4. The debug test system according to claim 3, wherein
the virtual register space comprises an inter process communication, IPC, mailbox.

5. The debug test system according to claim 1, wherein
the processing circuitry is further configured to transmit the control information by use of a JTAG connector and/or an in-band interrupt in I2C, I3C or a part of a universal serial bus load.

6. The debug test system according to claim 1, wherein
the control information comprises information about a flow of the debug session.

7. The debug test system according to claim 6, wherein
the information about the flow of the debug session comprises information about a deactivation of a target system reset timer.

8. The debug system according to claim 1, wherein
the control information comprises information about a power status of a hardware component of the target system.

9. A target system, comprising
one or more interfaces configured to communicate with a debug test system; and
processing circuitry configured to control the one or more interfaces and to:
transmit information about an operation state to the debug test system;
receive control information from the debug test system; and
adjust a parameter of a debug session based on the received control information.

10. The target system according to claim 9, wherein
if no control information is received within a predefined time the processing circuitry is further configured to proceed with the debug session without adjusting the parameter of the debug session.

11. The target system according to claim 9, wherein
the parameter of the debug session comprises a target system reset timer and wherein
the processing circuitry is further configured to deactivate the target system reset timer after transmitting the control information to the debug test system.

12. The target system according to claim 9, wherein
the parameter of the debug session comprises information about at least one element of the group of:
a target system reset timer;
a power status of a hardware component;
an addressed logic array of the debug session;
a context;
a logic failure of a processing unit; and
a debug session flow.

13. The target system according to claim 9, wherein
the processing circuitry is further configured to transmit the information about the operation state by use of a virtual register space, physical register, virtual register, wire or event.

14. The target test system according to claim 13, wherein
the virtual register space comprises an inter process communication, IPC, mailbox.

15. The target test system according to claim 9, wherein
the processing circuitry is further configured to transmit the control information by use of a JTAG connector and/or an in-band interrupt in I2C, I3C or a packet over universal serial bus.

16. A method for a debug test system, comprising
receiving information about an operation state of a target system from the target system;
generating control information for the target system to manage a debug session on the target system; and
transmitting the control information to the target system.

17. The method according to claim 15, further comprising
providing information about the operation state of the target system to a user; and
generating the control information for the target system based on a user input.

18. The method according to claim 15, wherein
the information about the operation state is transmitted by use of a virtual register space.

19. The method according to claim 15, wherein
the information about the flow of the debug session comprises information about a deactivation of a target system reset timer.

20. The method according to claim 15, wherein
the control information comprises information about a power status of a hardware component of the target system.

21. A non-transitory, computer-readable medium comprising a program code that, when the program code is executed on a computer, a processor, or a programmable hardware component, performs receiving information about an operation state of the target system from the target system, generating control information for the target system to manage a debug session on the target system and transmitting the control information to the target system.
